(19) United States
(12) Patent Application Publication
(10) Pub. No.: US 2023/0153720 A1
(43) Pub. Date: May 18, 2023

(54) MANAGEMENT OF OPERATIONS USING ELECTRIC VEHICLE DATA

(71) Applicant: Uber Technologies, Inc., San Francisco, CA (US)

(72) Inventors: Uday Kiran Medisetty, San Francisco, CA (US); Ankit Srivastava, San Francisco, CA (US)

(21) Appl. No.: 17/943,370

(22) Filed: Sep. 13, 2022

Related U.S. Application Data
(60) Provisional application No. 63/278,927, filed on Nov. 12, 2021.

(51) Int. Cl. G06Q 10/06; G06Q 10/08; G06Q 50/30

(52) U.S. Cl. CPC G06Q 10/06315; G06Q 10/08355; G06Q 50/30; G06Q 30/0202

(57) ABSTRACT

A system can receive EV data of an EV operated by a driver, where the EV data comprises at least one of a current electric charge of the EV or a current range of the EV. The system can further receive service requests from requesting users, where a subset of the service requests correspond to one or more item pickup locations within a predetermined distance or estimated time of travel of an EV charging station. Based at least in part on the EV data, the system (i) assigns the driver to the subset of service requests, and (ii) determines a route from a location of the EV to the EV charging station, and transmits information corresponding to the subset of service requests and data corresponding to the route to at least one of a computing device operated by the driver or a computing system associated with the EV.

### CROSS-REFERENCE TO RELATED APPLICATION

This application claims the benefit of priority to U.S. Provisional Application No. 63/278,927, filed on Nov. 12, 2021, which is hereby incorporated by reference in its entirety.

### BACKGROUND

A network-based service can enable users to request and receive various services through one or more applications on mobile computing devices. The network-based service can assign transport providers to various tasks requested by requesting users, such as on-demand rideshare, food delivery, package delivery, and the like. The ongoing development of electric vehicles (EVs) has driven a push towards cleaner, more affordable, and more efficient means of transportation for these services.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network computing system managing a set of network-based services, in accordance with examples described herein;

FIGS. 2A, 2B, and 3 are flowcharts describing example methods of optimizing tasks and routing based in part on EV data, in accordance with examples described herein;

FIG. 4 is a block diagram illustrating an example transport provider device executing and operating a designated transport provider application for communicating with a network computing system, according to examples described herein; and

FIG. 5 is a block diagram that illustrates a computer system upon which examples described herein may be implemented.

### DETAILED DESCRIPTION

A network computing system is provided herein that manages a set of network-based transport services linking available transport providers with requesting users throughout a given region (e.g., a metroplex such as the San Francisco Bay Area). In various implementations, the network computing system can receive various requests from the requesting users, which can comprise requests for on-demand transport (e.g., a standard rideshare request or carpool transport request) in which the computing system matches the request to an optimal driver (e.g., based on at least one of distance or time to the requesting user's start location) and transmits a service invitation for the request to a computing device of the optimal driver. In further implementations, the computing system can receive item pickup requests for on-demand food delivery, package delivery, grocery delivery, and the like, match each request to an optimal driver, and transmit a service invitation to the computing device of that driver accordingly. In various implementations, the driver may accept or decline the service invitation.

Certain services may involve tasks that can be comparatively more time consuming for the driver, such as on-demand grocery delivery or on-demand package delivery (e.g., requiring the driver to park, walk to a pickup location, carry items back to the vehicle, and load the items). For certain grocery delivery examples, the driver may be tasked with picking up pre-bagged groceries, or be given a list of items to purchase for the requesting user at a particular grocery store—the latter being particularly time consuming. On-demand package, food item, and grocery delivery can involve a single driver performing the tasks of multiple households by loading up a vehicle with multiple requested items. Through network interactions and remote coordination (e.g., via server communications between driver and/or requester software applications on mobile computing devices), these on-demand services can effectively reduce the number of vehicles on the road and/or reduce road traffic or congestion by replacing multiple vehicles of households with a single vehicle and/or driver, thereby reducing overall vehicle emissions. The further replacement of gas-powered vehicles with zero-emission EVs can further reduce or eliminate vehicle emissions from these tasks.

Drivers that operate EVs currently experience an advantage over drivers of gas-powered vehicles due to the significant discount provided by electric charging versus gasoline. However, EV drivers may also experience disadvantages when servicing requests from requesting users due to the time inefficiency of charging an EV, which can take up to an hour or more. For on-demand transportation, for example, the charge time of the EV amounts to downtime for the driver, who could otherwise be generating earnings by servicing ride requests with a gas-powered vehicle. A computing system is described herein that receives EV data (e.g., charge data and/or range data) from each EV currently available to service on-demand requests, and performs a set of routing and task optimizations for the drivers of EVs in order to significantly reduce or eliminate downtime during charging.

In various examples, the computing system can receive the EV data over one or more networks from the EVs via a computing system of the EV. Additionally or alternatively, the computing system can receive the EV data from a computing device of a driver of the EV, which can communicate with a computing system of the EV (e.g., via USB, ODBII port, or Bluetooth connection with the EV). For example, the driver may pair a computing device with the EV, which can communicate with a computing system or battery management system of the EV to receive the EV data. A designated application executing on the driver device (e.g., a transport service application enabling the driver to provide transport services described throughout the present disclosure) can automatically transmit the EV data to the backend computing system facilitating transport services over a given service region. Additionally or alternatively, the vehicle computing system of the EV can transmit EV data to a third-party computing system (e.g., manufacturer servers or fleet management servers), which can transmit the EV data to the backend computing system facilitating the transport services over the given region.

In various examples, the EV data can include a current charge level of the EV's battery and/or a current range (e.g., distance available to travel) of the EV. For example, each EV can include a communication interface that periodically or continuously transmits, over one or more networks, the current charge level and/or range estimate of the EV to the network computing system. The computing system can utilize the vehicle data from each EV to optimize task matching and routing of the driver, determine a charging station at which the driver is to recharge the vehicle based on a variety of factors, determine a particular time at which the driver is to charge the vehicle, and determine a time at which to unplug or disconnect the vehicle from the charging station and continue servicing requests.

In various implementations, the computing system can utilize (i) marketplace data indicating a current supply (and/or forecasted supply) of available drivers (e.g., using a combination of gas and electric powered vehicles) and current service demand (and/or forecasted demand) from requesting users for each of a set of on-demand services, and (ii) the charge information from each EV operated by drivers of the on-demand services to optimize task matching for the drivers of EVs, and provide these drivers with opportunities to continue servicing on-demand requests while their EVs are charging. In an example scenario, the computing system may route a transport provider operating a vehicle that is running low on electric charge to an electric charging station that is within a predefined distance or time of travel (e.g., walking distance) of a set of task locations that correspond to service requests (e.g., a package pickup location, grocery store, food item pickup location, etc.). The computing system can further determine or estimate a charge time for the vehicle, and assign and/or notify (via a notification message or data packet) the driver to perform a set of tasks while the vehicle is charging in order to reduce the downtime of the driver.

In another example, the computing system can perform timing optimizations for the pickup times of groceries, packages, and/or food items while an EV is charging (e.g., based on estimated prep times of grocery bagging and food items). For example, in the early phase of charging, the driver may be tasked with picking up nearby packages and/or grocery bags and load them into the EV. As the EV nears full charge (e.g., a charge time of ten minutes or less), the driver may be tasked with picking up a set of prepared food items at one or more nearby restaurants (e.g., to prevent the food items from getting cold) and unplugging the EV upon returning to the charging station to deliver the food items and loaded packages and groceries.

Different service demand conditions may also be determinative of whether to route an EV to a charging station to top up on charge while the driver performs a set of tasks. For example, an EV may have 50% charge, but the demand for rideshare in the vicinity of the vehicle may be comparatively low, while the demand for package, grocery, and/or food item pickup may be comparatively high. Based on this information, the computing system may route the driver to a charging station to plug in the EV (despite having ˜50% range) and match the driver to a set of pickup tasks to perform while increasing the range of the EV (e.g., for an anticipated surge in rideshare demand). When the pickup tasks are completed, the computing system may task the driver to unplug the vehicle, deliver the items, and service other requests accordingly.

The various service invitations and tasks may be presented to the driver via a customized user interface for the driver generated on the driver's computing device. The customized user interface can present notifications to the driver indicating service invitations, selectable content features that enable the driver to accept or decline each service invitation, and interactive content items that enable the driver to view current tasks matched to the driver, route plans, map interfaces presenting optimized routes for the EV driver, earnings information, and the like. In certain examples, the customized user interface enables the driver to opt out of or opt into certain on-demand services that the driver is willing to perform, such as on-demand rideshare, package delivery, grocery delivery, food item delivery, and other on-demand services. For EV drivers, the customized user interface may also present information indicating a charging station at which the driver is to plug in the EV while performing other tasks. When the EV driver opts out of certain on-demand services (e.g., grocery delivery), the customized user interface can present a notification indicating a set of service requests and/or an earnings estimate for servicing these requests while the EV is charging.

As used herein, the terms “optimize,” “optimization,” “optimizing,” and the like are not intended to be restricted or limited to processes that achieve the most optimal outcomes. Rather, these terms encompass technological processes (e.g., heuristics, stochastics modeling, machine learning, reinforced learning, Monte Carlo methods, Markov decision processes, etc.) that aim to achieve desirable results. Similarly, terms such as “minimize” and “maximize” are not intended to be restricted or limited to processes or results that achieve the absolute minimum or absolute maximum possible values of a metric, parameter, or variable.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

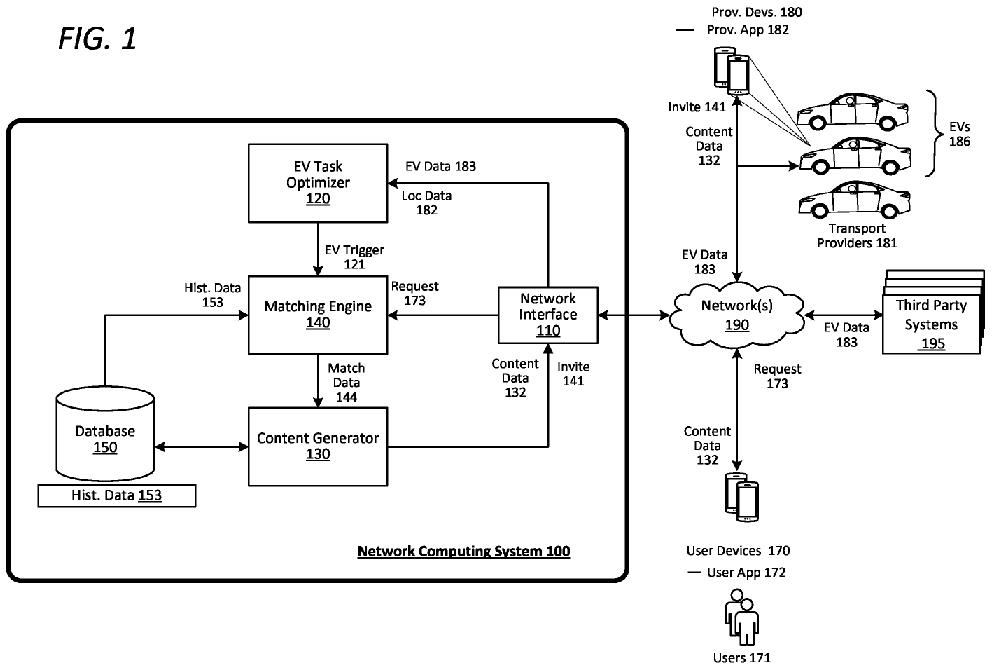

FIG. 1 is a block diagram illustrating an example network computing system 100 managing a set of network-based services, in accordance with examples described herein. The network computing system 100 can implement and manage a number of network services that connect requesting users 171 with transport providers 181 that are available to service the users' requests for service 173. The network services managed by the computing system 100 can comprise a platform that facilitates services to be requested and provided between requesting users 171 and available transport providers 181 by way of a user application 172 executing on the user devices 170 and a transport provider application 182 executing on the transport provider devices 180. As used herein, a user device 170 and a transport provider device 180 can correspond to a computing device with functionality to execute a designated application (e.g., a user application 172, a provider application 182, etc.) associated with the network services managed by the computing system 100. According to embodiments, the user device 170 and the transport provider device 180 can correspond to mobile computing devices, such as smartphones, tablet computers, VR or AR headsets, on-board computing systems of vehicles, smart watches, and the like.

The network computing system 100 can include a network interface 110 to communicate with user devices 170, transport provider devices 180, and/or third-party computer systems 195 (e.g., associated with the EVs 186) over one or more networks 190. For example, the network computing system 100 can communicate over the one or more networks 190 with the computing devices 170 of the users 171 and the computing devices 180 of the transport providers 181 via the designated applications (e.g., user application 172, transport provider application 182, etc.) executing on the devices. In various examples, the computing system 100 can further communicate with computing systems of EVs 186 to receive EV data 183. Additionally or alternatively, the computing system 100 can receive the EV data 183 from the computing devices 180 of the transport providers 181. In such examples, the transport provider 181 can pair or otherwise connect a computing device 180 with the computing system of the EV 186 (e.g., via USB, ODBII, Bluetooth, etc.), which can access the EV data 183 and transmit the EV data 183 to the computing system 100. In some examples, the computing systems of the EVs 186 can transmit the EV data 183 to third-party computing systems 195 (e.g., manufacturer computing systems or fleet management systems associated with the EVs 186), and the computing system 100 can obtain the EV data 183 from the third-party computing systems 195. As provided herein the EV data 183 can indicate a current charge of an EV 186 (e.g., twenty percent) or a current range of the EV 186 (e.g., fifty miles).

According to examples, a requesting user 171 wishing to utilize one or more of the network services can launch the user application 172 and transmit a request 173 for service over network 190 to the computing system 100. In certain implementations, the requesting user 171 can view multiple different rideshare service types managed by the network system 100, such as ride-pooling, a basic or economy service type, a luxury vehicle service type, a van or large vehicle service type, a professional transport provider service (e.g., in which the transport providers are certified), a self-driving vehicle service, a rickshaw service, and the like. In further examples, the requesting user 171 can request an item delivery service, such as a package delivery service, food item delivery service, grocery delivery service, and the like.

In various implementations, a transport provider 181 may launch the provider application 182 to indicate availability in servicing requests 173. Upon launching the application 182, the transport provider 181 can opt into or out of any of the above-mentioned services. For example, the transport provider 181 can indicate availability only for rideshare requests and opt out of item deliveries. Alternatively, the transport provider 181 can opt into all services managed by the computing system 100, indicating availability to service rideshare requests as well as any of the item delivery services.

Based on a received service request 173 from a requesting user 171, a matching engine 140 of the computing system 100 can determine one or more optimal transport providers 181 to service the request 173 (e.g., based on an estimated distance or time between the transport provider 181 and a pickup location of the requesting user 171 or item). For example, the computing system 100 can utilize location data 182 from the transport provider devices 180—indicating the current locations of the transport providers 181—to identify one or more candidate transport providers 181 to service the request 173. For item pickup requests, the matching engine 140 can identify the candidate transport providers 181 based on their proximity to a pickup location of the item. For rideshare requests, the matching engine 140 can identify the candidate transport providers based on their proximity to a pickup location of the requesting user 171.

In various implementations, the transport providers 181 can operate gasoline powered vehicles and EVs 186. It is contemplated that EVs 186 require significant time to recharge as compared to the refueling time for gasoline powered vehicles. Accordingly, transport providers 181 operating EVs 186 may experience significantly more downtime (e.g., time in which the transport provider 181 is unavailable to service requests 173 from requesting users 171). In accordance with examples provided herein, the computing system 100 can include an EV task optimizer 120 that receives EV data 183 and location data 182 from the EVs 186 and/or the provider computing devices 180 of transport providers operating the EVs 186. Based on the EV data 183 and location data 182, the task optimizer 120 can monitor a current charge level or range of each EV 186 operating throughout the transport service region.

In various implementations, the EV task optimizer 120 can further transmit an EV trigger 121 to the matching engine 140 of the computing system 100 when the charge level or range of an EV 186 drops below a certain threshold (e.g., ten percent charge or twenty miles of range). The EV trigger 121 can indicate to the matching engine 140 to prioritize matching the driver of the EV 186 with requests 173 that route the EV 186 towards an optimal EV charging station within range of the EV 186. In response, the matching engine 140 and EV task optimizer 120 can perform task matching and route optimization techniques that match the EV driver to one or more transport requests having a destination near an EV charging station. In further performing such optimization techniques, the matching engine 140 can further determine an optimal EV charging station for the EV 186 based on the service requests 173 received for the network services.

For example, based on the EV data 183, the EV task optimizer 120 can determine a set of EV charging stations within the EV's current range. The matching engine 140 can identify service locations of service requests 173 (e.g., rideshare routes having drop-off locations for requesting users 171 and/or item pickup locations for requesting users 171) that are proximate to EV charging stations that are within range of the EV 186. Based on the service locations of the service requests 173, the matching engine 140 can select an optimal EV charging station location for the EV 186 and match the driver of the EV 186 to a set of one or more service requests 173 that will route the EV 186 towards the optimal EV charging station and enable the driver of the EV 186 to perform tasks while the EV 186 is charging. As provided herein, these tasks can comprise item pickup tasks (e.g., grocery, food item, and/or package pickup tasks) at locations that are within a certain proximity of the optimal EV charging station.

In accordance with examples described herein, upon receiving an EV trigger from the EV task optimizer 120, the matching engine 140 can update a status of the EV driver to prioritize transport request matching such that the EV driver is routed towards an optimal EV charging station at which the EV driver can recharge the EV 186. As provided herein, this updated status can indicate that the EV driver is en route to an EV charging station, and that the matching engine 140 is to process current service requests 173 from requesting users 171 to match the EV driver with requests 173 that both progress the EV driver to the optimal EV charging station and enable the EV driver to service requests 171 (e.g., item pickup requests) while the EV 186 is charging at the optimal charging station.

In certain implementations, the EV task optimizer 120 can determine an estimated charging time for the EV 186 at the EV charging station. In further implementations, the EV task optimizer 120 can provide information corresponding to the EV charging time to the matching engine 140 to enable the matching engine 140 to identify a set of item pickup tasks having an estimated completion time that is similar to or within a certain time threshold of the EV charging time. For example, a set of item pickup tasks may correspond to the EV driver walking to one or more locations from the EV charging station to pick up requested items, performing additional tasks such as shopping for a requested set of grocery items, loading requested items into the EV, and/or making multiple trips to item pickup locations from the EV charging station. The matching engine 140 can utilize the estimated charging time and the estimated time for completing the set of tasks in order to assign the EV driver to tasks having a cumulative completion time that substantially matches the EV charging time. Upon identifying a set of tasks for the EV driver, the matching engine 140 can transmit one or more invitations 141 corresponding to the tasks to the computing device 180 of the EV driver, who can accept or decline the tasks accordingly.

In further examples, the computing system 100 can include a database 150 storing historical data 153 corresponding to peak request times and other demand conditions for the set of networks services. The historical data 153 can indicate when and where certain clusters of service requests 173 appear throughout a given region. As an example, midday hours and late evening hours can be correlated to increases in food item requests, whereas morning hours and early evening hours on weekdays can be correlated to increases in rideshare requests. The matching engine 140 can utilize the historical data 153 for performing timing optimizations for the EVs 186 with regard to routing EVs 186 to charging stations and determining unplug or disconnect times for the EVs 186.

As an example, the matching engine 140 can predict a surge in demand for a particular network service at a future time. Based on the predicted surge, the matching engine 140 may utilize the EV data 183 to determine one or more EVs 186 to top up on charge at an EV charging station in order to anticipate the predicted surge in rideshare demand. As another example, the matching engine 140 may predict an increase in food item requests for restaurants proximate to a charging station at a future time. Based on the predicted surge, the matching engine 140 can identify one or more EVs 186 that will have comparatively low range at the future time, and at a certain time prior to the predicted surge, route the EV(s) 186 toward the charging station and match the driver(s) to the anticipated food items requests as they are received.

In still further examples, the matching engine 140 can determine a current marketplace characteristic for each network service. The marketplace characteristic can correspond to a current number of service requests 173 in comparison to a current supply of available transport providers 181 to service the requests 173 within a given area. When demand is low for a particular network service, the matching engine 140 may determine to route certain EVs 186 to top up on charge, and when demand increases, the matching engine 140 can leverage the charging EVs 186 to unplug and continue servicing requests 173 accordingly.

Accordingly, based on the EV data 183, the EV task optimizer 120 and matching engine 140 can perform routing and task optimizations for marketplace balancing operations, such that EVs 186 can be routed to charging stations during relatively low rideshare demand conditions and unplugged when rideshare demand increases. Furthermore, the EV task optimizer 120 can provide the matching engine 140 with EV triggers 121 indicating candidate EVs 186 and charge levels or current ranges of the EVs 186 to enable the matching engine 140 to assign various item pickup tasks to the EV drivers to mitigate downtime during charging.

In further examples, the EV task optimizer 120 can receive charge availability information from the EV charging stations to determine whether a charge port or slot is available for the EV 186. In such examples, the EV task optimizer 120 can provide the availability information to the matching engine 140 to enable the matching engine 140 to determine an optimal EV charging station and/or charging slot for the EV 186 (e.g., based in part on received item pickup requests 173 having pickup locations proximate to the EV charging stations). In certain examples, the matching engine 140 can reserve a particular slot at the optimal EV charging station for the EV driver, and further assign the EV driver to the particular slot accordingly.

In various implementations, the computing system 100 can include a content generator 130 that receives match data 144 from the matching engine 140 to generate customized user interface features for the provider application 182 and the user application 172. The user interface features can be specific to the transport provider 181 and/or the user 171 based on the requests 173 configured and submitted by the user 171 and the provider assignments or matches made by the matching engine 140. For an EV driver, the content generator 130 can generate content items indicating a reserved charging slot at a charging station, transport or task invitations 141, routing information, and/or interactive task information for when the EV driver is routed to a charging station and assigned to a set of item pickup tasks.

In various examples, the content generator 130 can receive match data 144 from the matching engine 140, which can indicate the information corresponding to service requests 173 matched to an EV driver. The match data 144 can further indicate that an EV 186 has been matched to a charging station, as well as certain tasks that the EV driver is to perform while the EV 186 is charging. Based on this information, the content generator 130 can transmit content data 132 to the computing device 180 of the EV driver that causes the provider application 182 to generate a set of individualized and interactive content items that enable the EV driver to view assigned tasks, indicate when a task is in progress, indicate when a task has been completed (e.g., when the EV driver has picked up a food item), and indicate when all assigned tasks have been completed while the EV 186 is charging.

In scenarios in which a driver of an EV is running low on charge and has opted out of item delivery services, the content generator 130 can receive match data 144 from the matching engine 140 that indicate potential item delivery request matches for the EV driver, and in some examples, determine the estimated earnings for servicing the item delivery requests. The content generator 130 can cause an interactive content feature to be presented on the user interface of the provider application 182 presented on the provider device 180 of the EV driver. The interactive content feature can indicate the set of potential matches for the EV driver and/or the potential earnings for servicing the matches while the driver's EV is charging. In certain examples, the EV driver may interact with the content feature to accept the potential matches or decline them. Upon accepting the potential matches, the matching engine 140 can update a status of the EV driver (e.g., from an unavailable status to a local item pickup status indicating that the EV driver is available to pick up items within walking distance of the EV charging station). The matching engine 140 may automatically assign a set of item pickup tasks to the EV driver and/or can match the EV driver with new item delivery requests 173 having pickup locations near the EV charging station.

While the EV 186 is charging, at any given time the EV driver may be matched with an item pickup request having a pickup location within a certain proximity of the EV charging station (e.g., within walking distance). In various implementations, the EV task optimizer 120 can estimate a charge time for the EV 186 to reach full charge and indicate the charge time to the matching engine 140 for matching decisions. As such, the EV task optimizer 120 and matching engine 140 can monitor the charging progress of the EV 186 and account for the remaining charging time when matching the EV driver to item pickup tasks that are proximate to the EV charging station.

As described herein, the matching engine 140 can further monitor the marketplace conditions for each network service, which can indicate a current supply of available drivers for each service and the current service request demand for each service. In certain implementations, the matching engine 140 can utilize the marketplace conditions for a particular service (e.g., rideshare services) to determine whether the EV driver is to unplug or disconnect the EV from a corresponding charge port at the charging station and proceed with servicing transport requests. Determining an unplug time for the EV 186 can comprise a marketplace optimization that takes into account the current charge level of the EV 186 while it is charging, current available transport providers 181, and current service demand for service requests 173. For example, as the EV 186 is charging, the matching engine 140 may detect a surge in service requests 173 in an area including the EV charging station. To meet the surge in requests 173, the matching engine 140 can determine that the EV 186 has sufficient charge and range to be unplugged and switched to an available status. In such a scenario, the content generator 130 can transmit content data 132 to the computing device 180 of the EV driver, causing the user interface to present an unplug instruction and/or one or more service invitations 141 for one or more service requests 173.

Examples provided herein mitigate the downtime for EV drivers during charging by utilizing EV data 183 from operating EVs 186 and item delivery requests 173 from requesting users 171 to determine optimal charging times, charging locations, and unplug times for the EV drivers. Such examples can match the EV driver with tasks within reasonable proximity to the EV charging station such that the EV driver may continue working to service requests 173 while the EV is charging. Accordingly, the task optimizations using EV data 183 for EV drivers comprise a technical solution to a current problem experienced in the field of on-demand services.

### Methodology

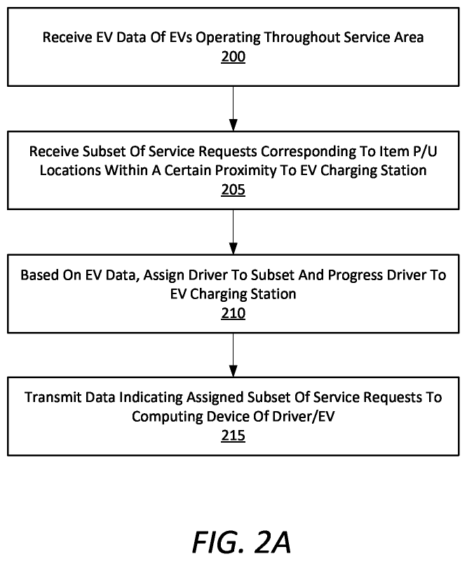

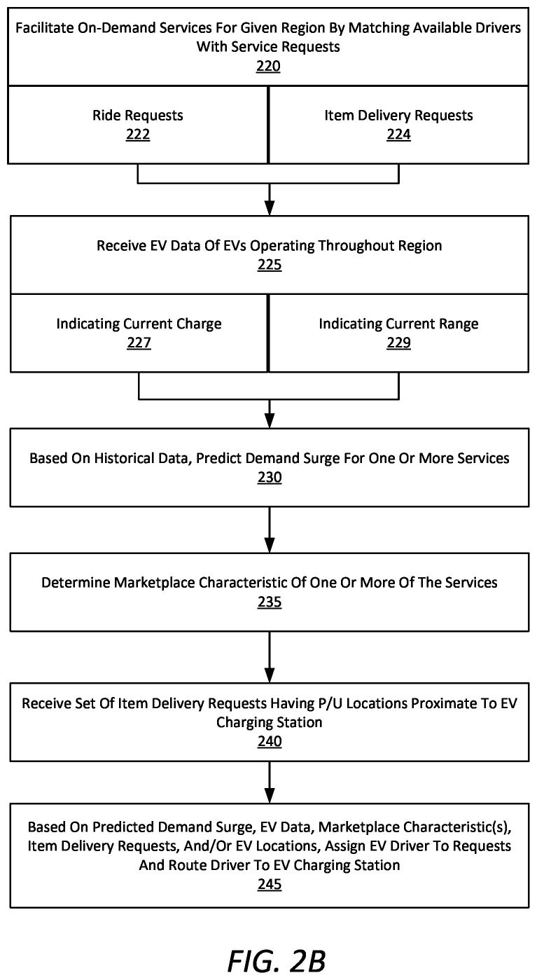

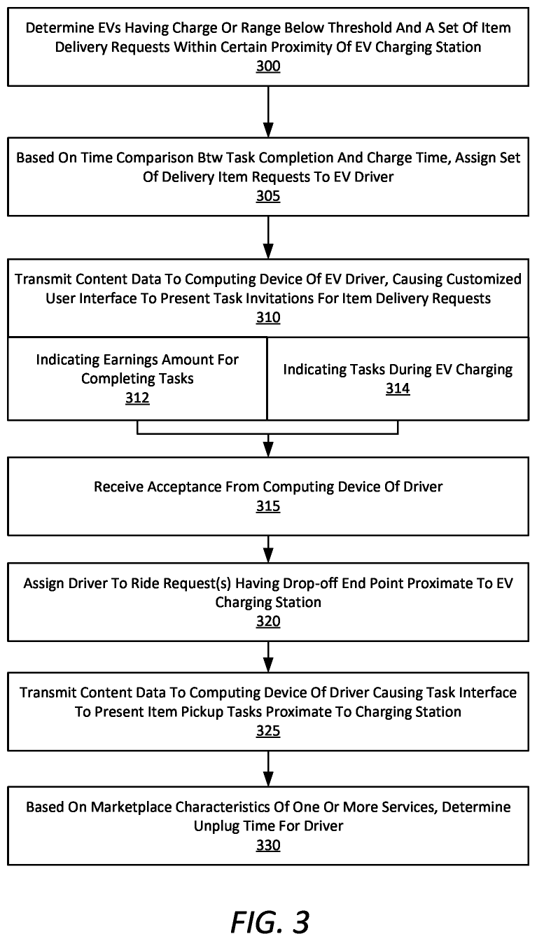

FIGS. 2A, 2B, and 3 are flowcharts describing example methods of optimizing tasks and routing based in part on EV data, in accordance with examples described herein. In the below discussion of FIGS. 2A, 2B, and 3, reference may be made to reference characters representing like features as shown and described with respect to FIG. 1. Furthermore, the processes described in connection with the flow charts of FIGS. 2A, 2B, and 3 need not be performed in any particular order, but rather any step may precede or follow any other step described.

Referring to FIG. 2A, the computing system 100 can receive EV data 183 of EVs 186 operating throughout a service area (200). As provided herein, the EV data 183 can be received from a computing system of the EV 186, the computing device 180 of the transport provider 181 operating the EV 186, and/or a third-party computing system 195 associated with the EV 186. The computing system 100 can further receive a subset of service requests 173 corresponding to item pickup locations within a certain proximity to an EV charging station (205). Based on the EV data 183, the computing system 100 can assign an EV driver to the subset of service requests 173 and progress the EV 186 to the EV charging station (210). In doing so, the computing system 100 can either route the EV 186 to the charging station directly, or match the EV driver to rideshare requests that progress the EV driver to the charging station. The computing system 100 may then transmit content data 132 to the computing device 180 of the EV driver and/or a computing system associated with the EV 186 (e.g., the computing system of the EV 186 itself or a third-party computing system 195 associated with the EV 186) to provide the driver with information corresponding to the subset of service requests 173, such as the items to be picked up and their pickup locations (215).

Referring to FIG. 2B, the computing system 100 can facilitate or manage a set of on-demand network services for a given region by matching available transport providers 181 with service requests 173 submitted by requesting users 171 (220). As described herein, the service requests 173 can comprise ride requests for transporting the requesting user 171 from a pickup location to the destination (222). As further described herein, the service requests 173 can comprise item delivery requests in which the transport provider 181 picks up one or more items (e.g., prepared food items, groceries, or packages) at a pickup location and delivers the item(s) to a location specified by the requesting user 171 (224).

In various examples, the computing system 100 can receive EV data 183 of EVs 186 operating throughout the given region (225). The EV data 183 can be received from a computing system of the EV 186, the computing device 180 of the transport provider 181 operating the EV 186, or a third-party computing system 195 associated with the EV 186. The EV data 183 can indicate a current charge of the EV 186 (227) and/or a current remaining range of the EV 186 (229). In various examples, the computing system 100 can further store historical data 153 indicating typical time intervals and locations or areas corresponding to surges in service requests 173 or periods of low demand. Based on the historical data 153, the computing system 100 can predict a demand surge for one or more of the networks services (230). In certain implementations, the computing system 100 can further determine a marketplace characteristic of each network service, such as a current number of service requests 173 for each service as compared to a current number of available transport providers 181 within a given area (235).

At any given time, the computing system 100 can receive a set of delivery requests having item pickup locations proximate to (e.g., within walking distance) an EV charging station (240). Based on the predicted demand surge, the EV data 183 from the EVs 186, the marketplace characteristics of each of the network services, the received item delivery requests, and/or the current locations of the EVs 186 operating in the given region, the computing system 100 can determine an optimal EV driver to assign to the item delivery requests and route the EV driver to the EV charging station (245).

As an example, the optimal EV driver may comprise a driver whose EV 186 is relatively low on charge and that is within a certain distance or time to the EV charging station (e.g., within five miles or ten minutes). The marketplace characteristic may indicate relatively low demand for rideshare services within the area of the charging station, whereas the computing system 100 has predicted a surge in rideshare demand for the given area at a future time (e.g., an hour in the future). Based on these factors and the received set of item delivery requests having pickup locations near the EV charging station, the computing system 100 may determine that the EV driver is most optimally utilized by charging the EV 186 at the charging station (e.g., to increase range for the anticipated surge in rideshare demand), and assigning the EV driver to the item delivery requests to enable the EV driver to perform the item pickups while the EV 186 is charging.

Referring to FIG. 3, the computing system 100 can monitor the EV data 183 from the EVs 186 operating throughout a given region to determine (i) a set of EVs 186 having a current charge level or range that is below a particular threshold (e.g., twenty miles or 10% charge), and (ii) a set of item delivery requests having pickup locations within a certain proximity of one or more EV charging stations (300). In certain implementations, the computing system 100 can determine an estimate charge time for each of the EVs 186 and an estimated time to complete the pickup tasks corresponding to the item delivery requests. Based on a time comparison between the charge time and completion time, the computing system 100 can assign the set of delivery item requests to an EV driver (305).

For example, certain item delivery requests may be less temporally sensitive than others, such as grocery delivery or package delivery as compared to prepared food item delivery. In some examples, the computing system 100 can queue these requests specifically for EV drivers having relatively low charge. As the EVs 186 operate and their charge levels decrease, the computing system 100 can perform task and routing optimizations to determine whether one or more of the EVs 186 would be most optimally utilized by being routed to a charging station and the EV driver matched to the item pickup tasks. If so, the computing system 100 can transmit content data 132 to the computing device 180 of the EV driver, causing a customized user interface to present a set of task invitations 141 for the item delivery requests (310).

In some examples, the user interface can present an estimated earnings amount for performing the item pickup tasks and subsequently delivering the items (312). The user interface can further indicate that the tasks are to be performed during charging of the EV 186 (314). In various examples, the EV driver can accept or decline the task invitations. In the example where the EV driver accepts the task invitations (315), the computing system 100 can assign the EV driver to one or more rideshare requests that have pickup and drop off locations that progress the EV driver to the EV charging station, and/or that have a final end point proximate to the EV charging station (320). Upon the EV 186 arriving at the EV charging station, the computing system 100 can transmit content data 132 to the computing device 180 of the EV driver, cause the computing device 180 to display a task interface presenting the item pickup tasks proximate to the charging station (325).

The EV driver can perform the tasks while the EV 186 is charging and indicate when each pickup task has been completed via inputs on the task interface. When the EV driver has indicated that all pickup tasks have been completed, the computing system 100 can monitor the marketplace characteristics of one or more of the network services, and determine an unplug time for the driver accordingly (330). For example, when the EV driver has picked up one or more prepared food items having a time-sensitive nature, the computing system 100 may instruct the EV driver to disconnect the EV from a charge terminal and proceed to deliver the items.

In further examples, the computing system 100 can determine an end time configured by the EV driver, which can indicate when and where the EV driver wishes to end a current session. For example, the EV driver may indicate via the provider application 182 that the driver wishes to be at a home location at a certain time. Based on such information, the computing system 100 may determine that a certain minimum amount of charge or range is all that is required for the EV driver to complete the item deliveries and perhaps service one or more additional requests before being routed to the home location at the end time of the EV driver's session. In such a scenario, the computing system 100 can transmit an unplug instruction to the computing device 180 of the EV driver when the EV 186 has a charge or range that has exceeded the minimum threshold.

### Hardware Diagrams

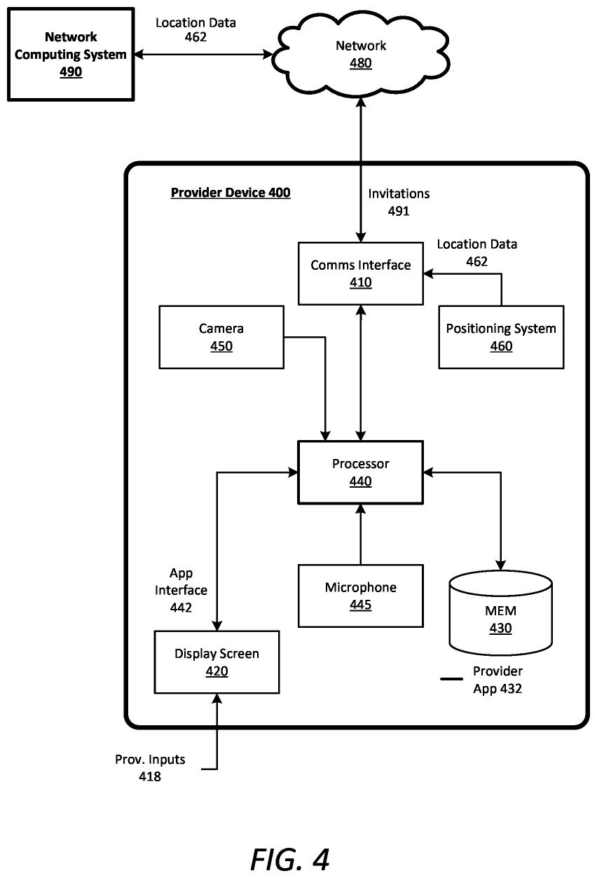

FIG. 4 is a block diagram illustrating an example transport provider device 400 executing and operating a designated transport provider application 432 for communicating with a network computing system 490, according to examples described herein. In many implementations, the transport provider device 400 can comprise a mobile computing device, such as a smartphone, tablet computer, laptop computer, and the like. As such, the transport provider device 400 can include typical telephony features such as a microphone 445, a camera 450, and a communication interface 410 to communicate with external entities using any number of wireless communication protocols. The transport provider device 400 can store a designated application (e.g., a transport provider app 432) in a local memory 430. In response to a provider input 418, the transport provider app 432 can be executed by a processor 440, which can cause an app interface 442 to be generated on a display screen 420 of the transport provider device 400. The app interface 442 can enable the transport provider to, for example, accept or reject invitations for service requests throughout a given region.

In various examples, the transport provider device 400 can include a positioning system 460, which can provide location data 462 indicating the current location of the transport provider to the network computing system 490 over a network 480. The network computing system 490 can determine whether the transport provider operating provider device 400 is a suitable match for a particular request. For EV transport providers, the network computing system 490 can further determine a current range or charge level of the driver's EV, determine when to route the EV driver to a charging station, and further determine a set of item pickup tasks that the EV driver can perform while the EV is charging.

In response to the transport provider being determined as a match for the particular request, the network computing system 490 transmits an invitation 491 relating to the particular request to the transport provider device 400. In response to receiving the invitation 491, the transport provider device 400 can present information relating to the invitation 491 and/or the particular request on the display screen 420. Receipt of the invitation 491 can also trigger an audio notification. The transport provider can interact with the transport provider application 432 to accept or decline the invitation 491.

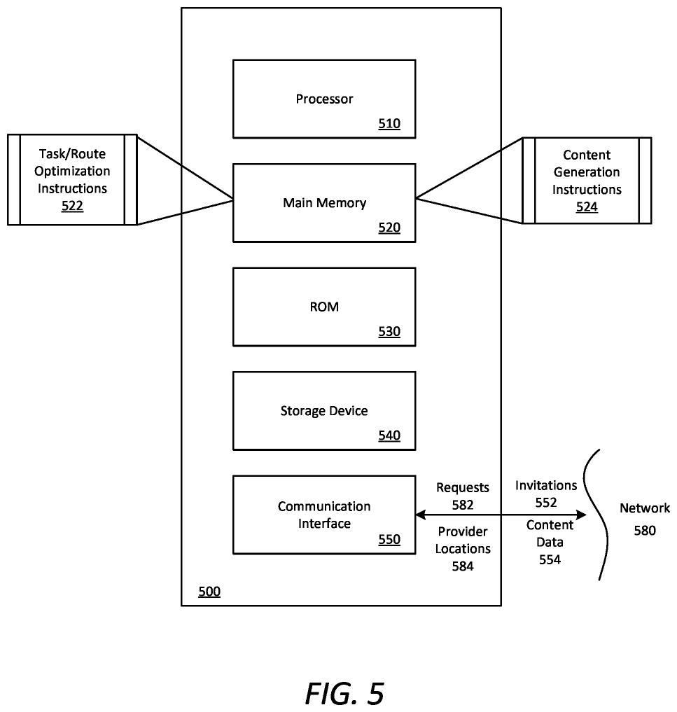

FIG. 5 is a block diagram that illustrates a computer system 500 upon which examples described herein may be implemented. A computer system 500 can be implemented on, for example, a server or combination of servers. For example, the computer system 500 may be implemented as part of a network service, such as described in FIGS. 1 through 4. In the context of FIG. 1, the computing system 100 may be implemented using a computer system 500 such as described by FIG. 5. The network computing system 100 may also be implemented using a combination of multiple computer systems 500 as described in connection with FIG. 5.

In one implementation, the computer system 500 includes processing resources 510, a main memory 520, a read-only memory (ROM) 530, a storage device 640, and a communication interface 550. The computer system 500 includes at least one processor 510 for processing information stored in the main memory 520, such as provided by a random-access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., cellular network) through use of the network link (wireless or wired). Using the network link, the computer system 500 can communicate with one or more computing devices, one or more servers, and/or one or more self-driving vehicles. In accordance with examples, the computer system 500 receives requests 582 from mobile computing devices of individual users. The executable instructions stored in the memory 530 can include task and route optimization instructions 522, which the processor 510 executes to select a transport provider to service the request 582. In doing so, the computer system 500 can receive transport provider locations 584 of transport providers operating throughout the given region, and the processor can execute the task and route optimization instructions 522 to identify a plurality of candidate transport providers for a given service request 582 and transmit invitation messages 552 to the candidate transport providers to enable the transport providers to accept or decline the invitations 552. The processor can further execute the task and route optimization instructions 522 to process EV data from EVs, determine when to route EV drivers to charging stations, and match EV drivers to walkable tasks while their EVs are charging, as described herein.

The executable instructions stored in the memory 520 can also include content generation instructions 524, which enable the computer system 600 to generate provider content data 554 for display on the provider devices. As described throughout, the content data 554 can be generated based on EV routing and the tasks provided to EV drivers while their EVs are charging. By way of example, the instructions and data stored in the memory 520 can be executed by the processor 510 to implement an example network computing system 100 of FIG. 1. In performing the operations, the processor 510 can receive requests 582 and transport provider locations 584, and submit invitation messages 552 to facilitate the servicing of the requests 582. The processor 510 is configured with software and/or other logic to perform one or more processes, steps and other functions described with implementations, such as described by FIGS. 1 through 4, and elsewhere in the present application.

Examples described herein are related to the use of the computer system 600 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system comprising:
a network communication interface;
one or more processors; and
a memory storing instructions that, when executed by the one or more processors, cause the computing system to:
receive, over one or more networks, electric vehicle (EV) data of an EV operated by a driver, the EV data comprising at least one of a current electric charge of the EV or a current range of the EV;
receive, over the one or more networks, service requests from requesting users, wherein a subset of the service requests correspond to one or more item pickup locations within a predetermined distance or estimated time of travel of an EV charging station, the EV charging station being capable of charging the EV operated by the driver;
based at least in part on the EV data, (i) assign the driver to the subset of service requests, and (ii) determine a route from a location of the EV to the EV charging station; and
transmit, over the one or more networks, information corresponding to the subset of service requests and data corresponding to the route to at least one of a computing device operated by the driver or a computing system associated with the EV.

2. The computing system of claim 1, wherein the service requests correspond to a plurality of services, the plurality of service comprising a plurality of a transport service, a package delivery service, a grocery delivery service, or a food item delivery service, and wherein the one or more item pickup locations comprise at least one of a package pickup location, a grocery pickup location, or a food item pickup location.

3. The computing system of claim 1, wherein the executed instructions further cause the computing system to:
transmit, over the one or more networks, content data to the computing device of the driver of the EV, the content data causing the computing device of the driver to present a set of interactive content items, each interactive content item corresponding to a task associated with a service request in the subset of service requests assigned to the driver.

4. The computing system of claim 1, wherein the executed instructions further cause the computing system to:
transmit, over the one or more networks, content data to the computing device of the driver, the content data causing a map interface to be displayed on the computing device of the driver, the map interface providing a driving route to the EV charging station and a travel route for servicing the subset of service requests while the EV is charging.

5. The computing system of claim 2, wherein the executed instructions further cause the computing system to:
for each service in the plurality of services, determine a marketplace characteristic within a service area of the driver, the marketplace characteristic indicating a current supply of available drivers and a current number of service requests for the service;
wherein the executed instructions cause the computing system to further determine the route to the EV charging station and assign the driver to the subset of service requests based on the marketplace characteristic of each service within the service area of the driver.

6. The computing system of claim 5, wherein the executed instructions further cause the computing system to:
predict, based on historical marketplace data, a surge in service requests for one or more services of the plurality of services at a future time period within the service area of the driver;
wherein the executed instructions cause the computing system to further determine the route to the EV charging station and assign the driver to the subset of service requests based on the predicted surge in service requests for the one or more services.

7. The computing system of claim 6, wherein the predicted surge in service requests corresponds to a predicted surge in transport service requests at the future time period within the service area of the driver, and wherein the executed instructions cause the computing system to route the driver of the EV to the EV charging station and assign the driver to the subset of service requests in order to increase a range of the EV for the predicted surge in transport requests.

8. The computing system of claim 2, wherein the executed instructions cause the computing system to:
determine an estimate charging time of the EV at the EV charging station; and
determine an estimated completion time for performing each task corresponding to the subset of service requests.

9. The computing system of claim 8, wherein the executed instructions cause the computing system to further route the driver of the EV to the EV charging station and assign the driver to the subset of service requests based on a comparison between the estimated charging time and the estimated completion time.

10. The computing system of claim 8, wherein the executed instructions further cause the computing system to:
based on the comparison between the estimated charging time and the estimated completion time, determine an unplug time at which the driver is to unplug the EV and exit the EV charging station.

11. The computing system of claim 10, wherein the unplug time corresponds to a time at which the EV is not fully charged.

12. The computing system of claim 10, wherein the executed instructions further cause the computing system to determine the unplug time based on a marketplace characteristic of one or more services of the plurality of services, the marketplace characteristic indicating a current supply of available drivers and a current number of service requests for each of the one or more services.

13. The computing system of claim 12, wherein the marketplace characteristic indicates an increase in service requests for the one or more services.

14. A non-transitory computer readable medium storing instructions that, when executed by one or more processors of a computing system, cause the computing system to:
receive, over one or more networks, EV data of an EV operated by a driver, the EV data comprising at least one of a current electric charge of the EV or a current range of the EV;
receive, over the one or more networks, service requests from requesting users, wherein a subset of the service requests correspond to one or more item pickup locations within a predetermined distance or estimated time of travel of an EV charging station, the EV charging station being capable of charging the EV operated by the driver;
based at least in part on the EV data, (i) assign the driver to the subset of service requests, and (ii) determine a route from a location of the EV to the EV charging station; and
transmit, over the one or more networks, information corresponding to the subset of service requests and data corresponding to the route to at least one of a computing device operated by the driver or a computing system associated with the EV.

15. The non-transitory computer readable medium of claim 14, wherein the service requests correspond to a plurality of services, the plurality of service comprising a plurality of a transport service, a package delivery service, a grocery delivery service, or a food item delivery service, and wherein the one or more item pickup locations comprise at least one of a package pickup location, a grocery pickup location, or a food item pickup location.

16. The non-transitory computer readable medium of claim 14, wherein the executed instructions further cause the computing system to:
transmit, over the one or more networks, content data to the computing device of the driver of the EV, the content data causing the computing device of the driver to present a set of interactive content items, each interactive content item corresponding to a task associated with a service request in the subset of service requests assigned to the driver.

17. The non-transitory computer readable medium of claim 14, wherein the executed instructions further cause the computing system to:
transmit, over the one or more networks, content data to the computing device of the driver, the content data causing a map interface to be displayed on the computing device of the driver, the map interface providing a driving route to the EV charging station and a travel route for servicing the subset of service requests while the EV is charging.

18. The non-transitory computer readable medium of claim 15, wherein the executed instructions further cause the computing system to:
for each service in the plurality of services, determine a marketplace characteristic within a service area of the driver, the marketplace characteristic indicating a current supply of available drivers and a current number of service requests for the service;
wherein the executed instructions cause the computing system to further determine the route to the EV charging station and assign the driver to the subset of service requests based on the marketplace characteristic of each service within the service area of the driver.

19. The non-transitory computer readable medium of claim 18, wherein the executed instructions further cause the computing system to:
predict, based on historical marketplace data, a surge in service requests for one or more services of the plurality of services at a future time period within the service area of the driver;
wherein the executed instructions cause the computing system to further determine the route to the EV charging station and assign the driver to the subset of service requests based on the predicted surge in service requests for the one or more services.

20. A computer-implemented method of managing a plurality of services, the method being performed by one or more processors and comprising:
receiving, over one or more networks, EV data of an EV operated by a driver, the EV data comprising at least one of a current electric charge of the EV or a current range of the EV;
receiving, over the one or more networks, service requests from requesting users, wherein a subset of the service requests correspond to one or more item pickup locations within a predetermined distance or estimated time of travel of an EV charging station, the EV charging station being capable of charging the EV operated by the driver;
based at least in part on the EV data, (i) assigning the driver to the subset of service requests, and (ii) determining a route from a location of the EV to the EV charging station; and
transmitting, over the one or more networks, information corresponding to the subset of service requests and data corresponding to the route to at least one of a computing device operated by the driver or a computing system associated with the EV.
